(19) United States
(12) Patent Application Publication
(10) Pub. No.: US 2019/0220268 A1
(43) Pub. Date: Jul. 18, 2019

(54) GATEWAY DEVICE, FIRMWARE UPDATE METHOD, AND COMPUTER READABLE MEDIUM

(71) Applicant: Mitsubishi Electric Corporation, Tokyo (JP)

(72) Inventor: Daisuke SUZUKI, Tokyo (JP)

(73) Assignee: Mitsubishi Electric Corporation, Tokyo (JP)

(21) Appl. No.: 16/307,011

(22) PCT Filed: Jul. 26, 2016
(86) PCT No.: PCT/JP2016/071914

§ 371 Date: Dec. 4, 2018

(51) Int. Cl. G06F 8/65; H04L 29/06; H04W 12/12; H04W 24/02; H04L 12/24

(52) U.S. Cl. CPC G06F 8/65; H04L 63/02; H04L 63/20; H04W 88/16; H04W 24/02; H04L 41/082; H04W 12/1201

(57) ABSTRACT

A radio wave quality measurement unit (407) measures radio wave quality in a radio communication link with an embedded appliance in which firmware is installed. A determination unit (406) determines whether update firmware (102) for update of the firmware is to be transmitted through the radio communication link to the embedded appliance or not, based on a measurement result of the radio wave quality measurement unit (407).

### TECHNICAL FIELD

The present invention relates to update of firmware of an embedded appliance.

### BACKGROUND ART

In general, software that specifies operations of an embedded appliance is referred to as firmware.

With networking of embedded appliances in recent years, opportunities for end users to update the firmware for purposes of strengthening of functions and bug fixing in the embedded appliances have been increasing.

Even for embedded appliances, such as refrigerators, air conditioners, and thermostats, which had not been conventionally connected to networks, such update of the firmware by the end users has been necessitated by connection of the embedded appliances to the networks.

The update of the firmware by an end user is carried out in accordance with following procedures, for instance.

(1) The end user acquires a file of firmware for the update (which will be referred to as update firmware, hereinbelow) from a website of a manufacturer of the embedded appliance.
(2) The end user inputs the file of the update firmware into the embedded appliance that is an object.
(3) The embedded appliance rewrites the currently installed firmware into the update firmware.

As a technique related to the update of the firmware, there exists a technique disclosed in Patent Literature 1.

### CITATION LIST

### Patent Literature

Patent Literature 1: JP 2016-85654A

### SUMMARY OF INVENTION

### Technical Problem

Neglect of the update of firmware of Wi-Fi routers by ordinary end users has caused a social problem in that the Wi-Fi routers may be improperly used as relay points referred to as stepping stones for attack. As clarified by this problem, even though ordinary end users are requested to update the firmware, it is often that the update of the firmware is not sufficiently carried out, in fact.

For high-level OS (Operating System) such as Windows (a registered trademark), in general, the update of the firmware is facilitated by application of patches. In embedded appliances, by contrast, the update of the firmware is often equivalent to rewriting of overall programs including OS. Therefore, failure in the update of the firmware in an embedded appliance may make it impossible to activate the OS for the embedded appliance. Once it is made impossible to activate the OS for the embedded appliance, it is difficult for an ordinary end user to restore the embedded appliance.

Thus a risk that it may be made impossible to activate the OS is conceived to be one of reasons why ordinary end users may not update the firmware of the embedded appliances.

The present invention mainly aims at increasing a possibility that users succeed in updating firmware of embedded appliances.

### Solution to Problem

A gateway device according to the present invention includes:

a radio wave quality measurement unit to measure radio wave quality in a radio communication link with an embedded appliance in which firmware is installed; and

a determination unit to determine whether update firmware for update of the firmware is to be transmitted through the radio communication link to the embedded appliance or not, based on a measurement result of the radio wave quality measurement unit.

### Advantageous Effects of Invention

According to the invention, the users are enabled to update the firmware at timing when the radio wave quality is satisfactory that is timing with a high possibility that the users may succeed in the update of the firmware. According to the invention, therefore, the possibility that the users may succeed in the update of the firmware of the embedded appliances may be increased.

### BRIEF DESCRIPTION OF DRAWINGS

FIG. 1 is a diagram illustrating a configuration example of a firmware update system according to Embodiment 1.

FIG. 2 is a diagram illustrating an example of a firmware update screen on a gateway device according to Embodiment 1.

FIG. 3 is a diagram illustrating an example of a firmware update screen on the gateway device according to Embodiment 1.

FIG. 4 is a diagram illustrating a functional configuration example of the gateway device according to Embodiment 1.

FIG. 5 is a flowchart illustrating an example of operations of the gateway device according to Embodiment 1.

FIG. 6 is a flowchart illustrating the example of the operations of the gateway device according to Embodiment 1.

FIG. 7 is a diagram illustrating a hardware configuration example of the gateway device according to Embodiment 1.

### DESCRIPTION OF EMBODIMENTS

Hereinbelow, an embodiment of the invention will be described with use of the drawings. In following description and the drawings of the present embodiment, elements provided with identical reference characters represent identical parts or corresponding parts.

### Embodiment 1

***Description on Configurations***

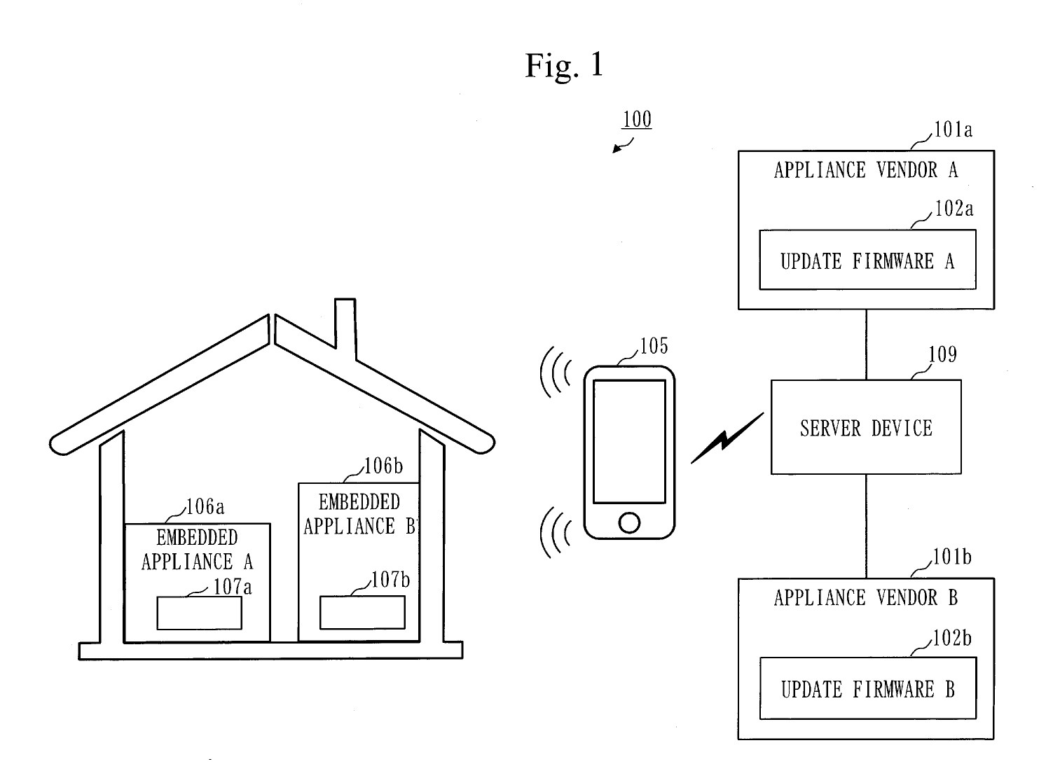

FIG. 1 illustrates a configuration example of a firmware update system 100 according to the present embodiment.

The firmware update system 100 according to the present embodiment is composed of an appliance vendor A 101a, update firmware A 102a, an appliance vendor B 101b, update firmware B 102b, a gateway device 105, an embedded appliance A 106a, an embedded appliance B 106b, and a server device 109.

The embedded appliance A 106a and the embedded appliance B 106b are installed in an arbitrary space such as a house, a building, or a factory, for instance. The embedded appliance A 106a and the embedded appliance B 106b are each an air conditioner, a refrigerator, a television, a remote controller, a thermostat, or the like.

A microcomputer A 107a is included in the embedded appliance A 106a. A microcomputer B 107b is included in the embedded appliance B 106b.

The microcomputer A 107a executes firmware A (not illustrated in FIG. 1). The microcomputer B 107b executes firmware B (not illustrated in FIG. 1).

Hereinbelow, the embedded appliance A 106a and the embedded appliance B 106b will be collectively referred to as embedded appliance 106 unless required to be distinguished.

The appliance vendor A 101a is a manufacturer of the embedded appliance A 106a or a business operator to which an update process for the firmware is entrusted by the manufacturer (both will be collectively referred to as business operator, hereinafter). The appliance vendor A 101a retains the update firmware A 102a for the update of the firmware A installed in the embedded appliance A 106a.

The appliance vendor B 101b is a business operator for the embedded appliance B 106b. The appliance vendor B 101b retains the update firmware B 102b for the update of the firmware B installed in the embedded appliance B 106b.

The appliance vendor A 101a uploads the update firmware A 102a to the server device 109 and the appliance vendor B 101b uploads the update firmware B 102b to the server device 109.

Hereinbelow, the update firmware A 102a and the update firmware B 102b will be collectively referred to as update firmware 102 unless required to be distinguished.

The server device 109 delivers the update firmware 102 to the gateway device 105.

The gateway device 105 is a portable gateway device. The gateway device 105 is a smartphone, for instance.

The gateway device 105 periodically accesses the server device 109 so as to check presence or absence of the update firmware 102. In the presence of the update firmware 102 in the server device 109, the gateway device 105 downloads the update firmware 102 from the server device 109.

Then the gateway device 105 transmits the downloaded update firmware 102 to the embedded appliance 106 by near field communication such as Bluetooth (a registered trademark) or ZigBee.

Upon reception of the update firmware A 102a, the embedded appliance A 106a rewrites the firmware A into the update firmware A 102a. Upon reception of the update firmware B 102b, the embedded appliance B 106b rewrites the firmware B into the update firmware B 102b.

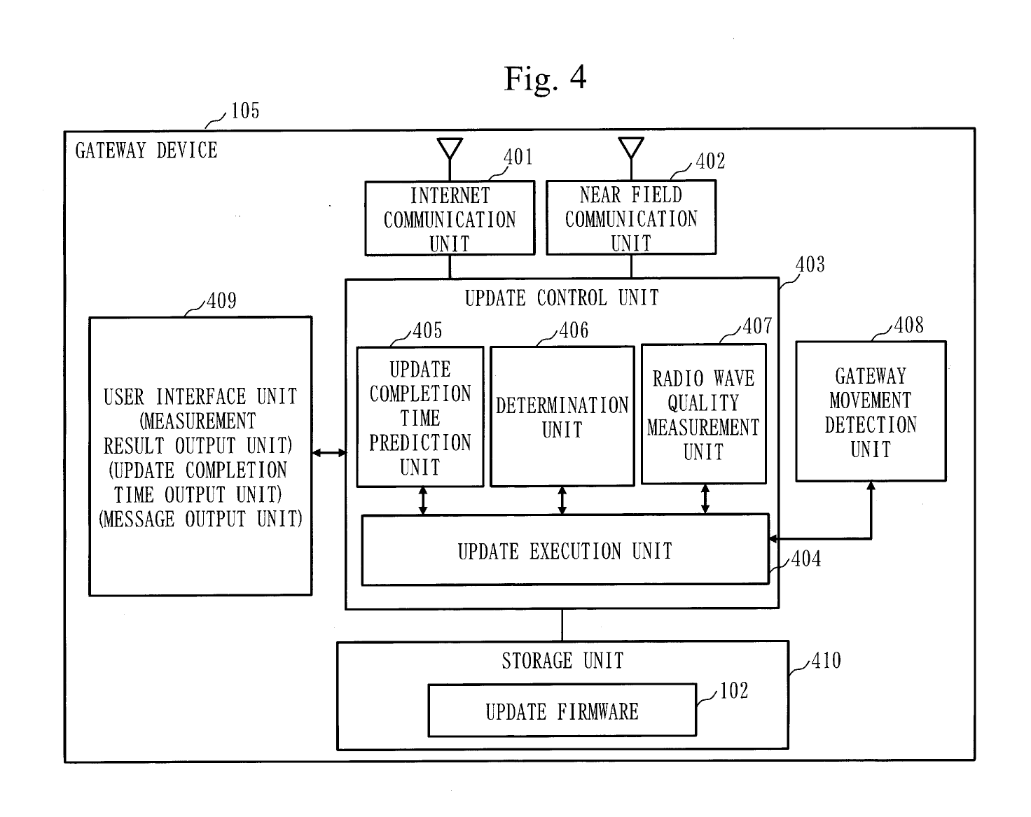

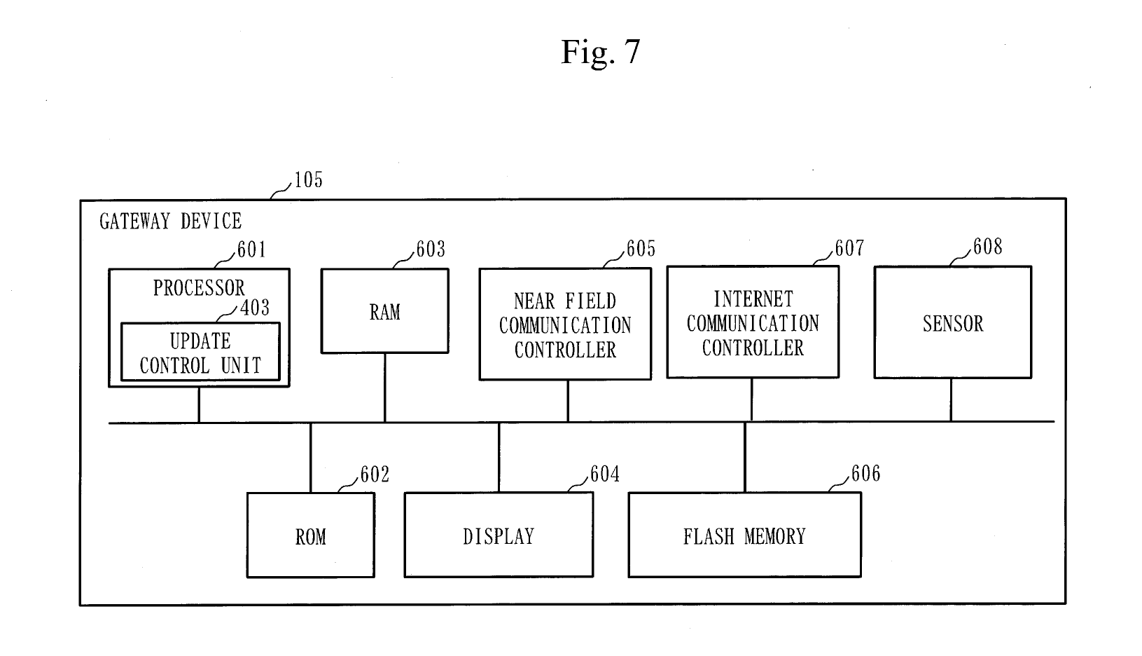

FIG. 4 illustrates a functional configuration of the gateway device 105 and FIG. 7 illustrates a hardware configuration example of the gateway device 105.

With reference to FIG. 7, initially, the hardware configuration example of the gateway device 105 will be described.

As illustrated in FIG. 7, the gateway device 105 is composed of a processor 601, a ROM (Read Only Memory) 602, a RAM (Random Access Memory) 603, a display 604, a near field communication controller 605, a flash memory 606, an Internet communication controller 607, and a sensor 608.

The processor 601 implements an update control unit 403 illustrated in FIG. 4. That is, the processor 601 executes a program that fulfils functions of the update control unit 403.

The program that fulfils the functions of the update control unit 403 is stored in the flash memory 606. The program that fulfils the functions of the update control unit 403 is loaded into the RAM 603 and is then executed by the processor 601.

FIG. 7 schematically illustrates a state in which the processor 601 executes the program that fulfils the functions of the update control unit 403.

The ROM 602 stores configuration information that is used in the gateway device 105, or the like.

As a storage unit 410 of FIG. 4, the flash memory 606 stores the update firmware 102, as well as the program that fulfils the update control unit 403.

The display 604 displays a display screen such as a firmware update screen that will be described later.

The display 604 is a touch-screen display, for instance. Thus it is made possible for a user of the gateway device 105 to input an instruction to the gateway device 105 by operation of a button, a check box, or the like displayed on the display 604. The display 604 implements a user interface unit 409 of FIG. 4.

The near field communication controller 605 implements a near field communication unit 402 of FIG. 4. The near field communication controller 605 is a radio communication chip for Bluetooth (a registered trademark) or ZigBee, for instance.

The Internet communication controller 607 implements an Internet communication unit 401 of FIG. 4. Specifically, the Internet communication controller 607 is a communication chip for 4G, LTE (Long Term Evolution) (a registered trademark), Wifi, or the like.

The sensor 608 detects movement of the gateway device 105. The sensor 608 implements a gateway movement detection unit 408 of FIG. 4.

With reference to FIG. 4, subsequently, the functional configuration example of the gateway device 105 will be described.

The Internet communication unit 401 receives the update firmware 102 from the server device 109. The Internet communication unit 401 carries out communication with use of 4G, LTE (a registered trademark), Wi-fi, or the like, for instance.

The near field communication unit 402 transmits the update firmware A 102a to the embedded appliance A 106a and transmits the update firmware B 102b to the embedded appliance B 106b. The near field communication unit 402 carries out communication with use of Bluetooth (a registered trademark), Low Energy, ZigBee, or the like, for instance.

The update control unit 403 exerts control for the update of the firmware of the embedded appliance 106.

The update control unit 403 is composed of an update execution unit 404, an update completion time prediction unit 405, a determination unit 406, and a radio wave quality measurement unit 407.

The update execution unit 404 stores the update firmware 102, received by the Internet communication unit 401, in the storage unit 410.

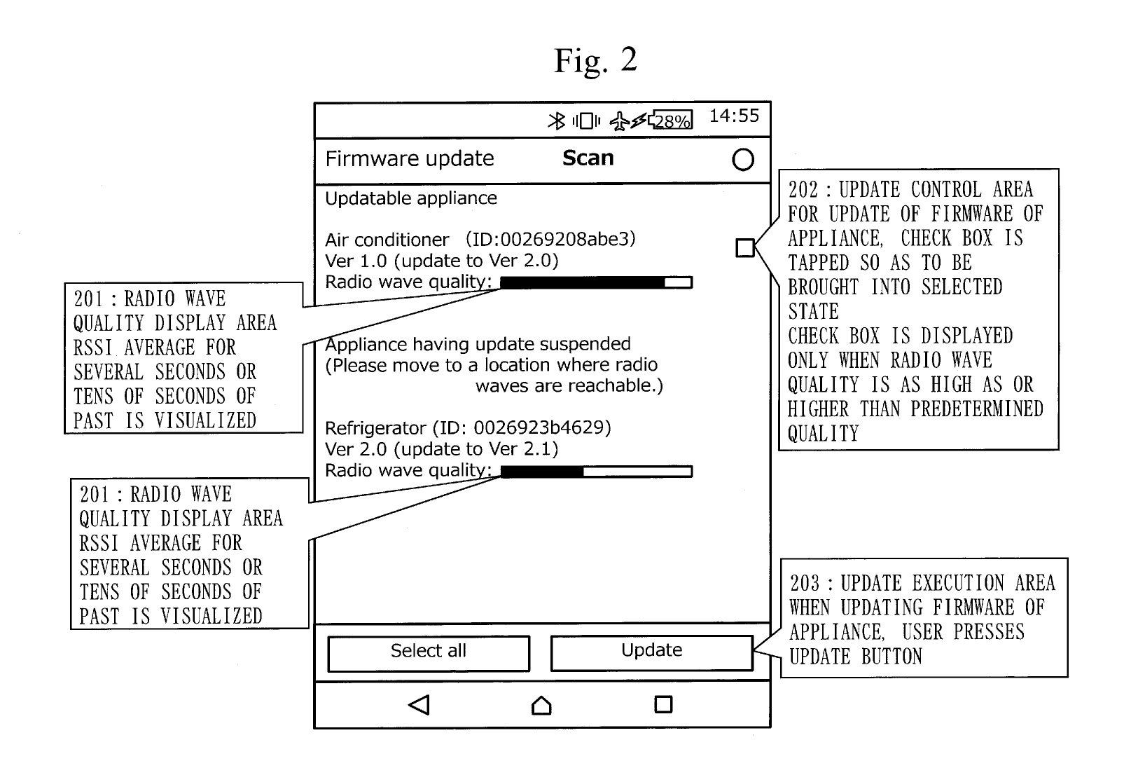

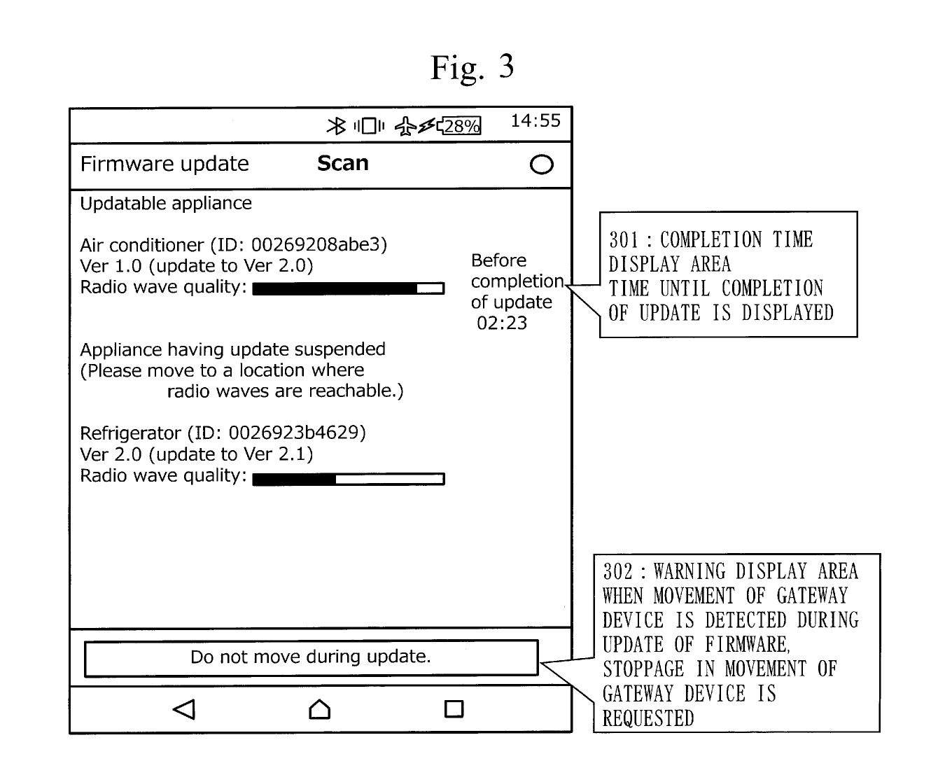

The update execution unit 404 generates the firmware update screen (FIG. 2, FIG. 3) that is to be presented to the user by the user interface unit 409.

In case where the determination unit 406 determines that the update firmware 102 is to be transmitted to the embedded appliance 106 and where an instruction to transmit the update firmware 102 to the embedded appliance 106 is given from the user of the gateway device 105, the update execution unit 404 transmits the update firmware 102 in the storage unit 410 through the near field communication unit 402 to the embedded appliance 106.

The update completion time prediction unit 405 predicts update completion time that is time until completion of the update of the firmware.

The radio wave quality measurement unit 407 measures radio wave quality in a radio communication link with the embedded appliance 106. That is, the radio wave quality measurement unit 407 receives information on RSSI (Received Signal Strength Indicator) from the near field communication unit 402 via the update control unit 403 and measures the radio wave quality. Then the radio wave quality measurement unit 407 outputs a measurement result on the radio wave quality to the update execution unit 404. The radio communication link is a radio channel that the near field communication unit 402 uses for the communication with the embedded appliance 106 and that is for Bluetooth (a registered trademark), Low Energy, ZigBee, or the like.

The radio wave quality measurement unit 407 detects movement of the embedded appliance 106 by measuring the radio wave quality in the radio communication link. The radio wave quality measurement unit 407 functions as an appliance movement detection unit as well.

Operations that are carried out by the radio wave quality measurement unit 407 are equivalent to the radio wave quality measurement process.

The determination unit 406 acquires the measurement result of the radio wave quality measurement unit 407 from the update execution unit 404. The determination unit 406 then determines whether the update firmware 102 is to be transmitted through the radio communication link to the embedded appliance 106 or not. The determination unit 406 outputs a result of determination to the update execution unit 404.

Operations that are carried out by the determination unit 406 are equivalent to the determination process.

The gateway movement detection unit 408 detects the movement of the gateway device 105.

The storage unit 410 stores the update firmware 102 received by the Internet communication unit 401.

The user interface unit 409 displays the firmware update screen as illustrated as examples in FIGS. 2 and 3, to the user. The firmware update screens of FIGS. 2 and 3 are generated by the update execution unit 404 as described above.

FIG. 2 illustrates the example of the firmware update screen that is displayed by the user interface unit 409 before the update of the firmware of the embedded appliance 106. FIG. 3 illustrates the example of the firmware update screen that is displayed by the user interface unit 409 during the update of the firmware of the embedded appliance 106.

The user interface unit 409 is an example of the measurement result output unit, the update completion time output unit, and the message output unit.

Hereinbelow, details of the firmware update screen of FIG. 2 and the firmware update screen of FIG. 3 will be described.

In FIG. 2, the radio wave quality measured by the radio wave quality measurement unit 407 is displayed in a radio wave quality display area 201. In the radio wave quality display area 201, an average of RSSI for several seconds or tens of seconds of past is visualized by an indicator such as a graph.

A message “Updatable appliance” is displayed for the embedded appliance 106 whose radio wave quality is as high as or higher than predetermined quality. By contrast, a message “Appliance having update suspended” is displayed for the embedded appliance 106 whose radio wave quality is lower than the predetermined quality. In addition, a message “Please move to a location where radio waves are reachable.” is displayed for the embedded appliance 106 whose radio wave quality is lower than the predetermined quality, so that the user is requested to make the gateway device 105 closer to the embedded appliance 106 whose radio wave quality is insufficient. In the example of FIG. 2, the radio wave quality in the radio communication link between the gateway device 105 and the air conditioner is as high as or higher than the predetermined quality. By contrast, the radio wave quality in the radio communication link between the gateway device 105 and the refrigerator is lower than the predetermined quality.

In an update control area 202, a check box is displayed for the embedded appliance 106 whose radio wave quality is as high as or higher than the predetermined quality. When updating the firmware of the embedded appliance 106, the user taps the check box so as to bring the check box into a selected state. The check box is not displayed for the embedded appliance 106 whose radio wave quality is lower than the predetermined quality, so that the user cannot give an instruction to update the firmware of the embedded appliance 106 whose radio wave quality is unsatisfactory.

In an update execution area 203, an update button is displayed on condition that the check box or the check boxes for one or more embedded appliances 106 are in the selected state. When updating the firmware of the embedded appliances 106, the user presses the update button.

When the update button is pressed by the user, the update execution unit 404 determines that the instruction to update the firmware of the embedded appliances 106 for which the check boxes in the update control area 202 are in the selected state is given by the user.

In FIG. 3, the update completion time predicted by the update completion time prediction unit 405 is displayed in a completion time display area 301.

In a warning display area 302, when the movement of the gateway device 105 is detected by the gateway movement detection unit 408 during the update of the firmware, a warning message that requests the user to stop the movement of the gateway device 105 is displayed.

There is a possibility that the movement of the gateway device 105 may cause a change in the radio wave quality in the radio communication links with the embedded appliances 106 whose firmware is being updated. When the movement of the gateway device 105 is detected, therefore, the warning message that requests a stoppage in the movement of the gateway device 105 is displayed in the warning display area 302. In the example of FIG. 3, the example in which the warning message saying “Do not move during update.” is displayed is illustrated. The stoppage in the movement of the gateway device 105 may be requested by flashing, vibrations, or sounds, instead of the message illustrated as the example in FIG. 3. In case where the embedded appliance 106 whose firmware is being updated is a portable embedded appliance such as a remote controller, the user can move the embedded appliance 106 whose firmware is being updated. In such a case, the radio wave quality in the radio communication link between the embedded appliance 106 and the gateway device 105 is changed. When the radio wave quality in the radio communication link with the embedded appliance 106 whose firmware is being updated is deteriorated, therefore, a warning message saying “Do not move appliance during update.” is displayed.

***Description on Operations***

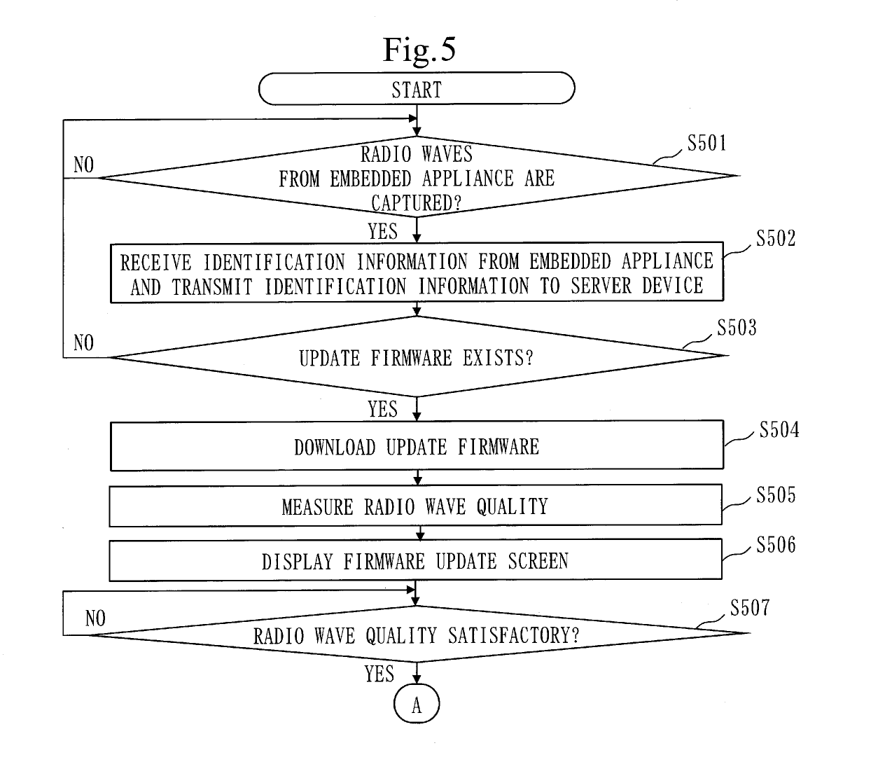

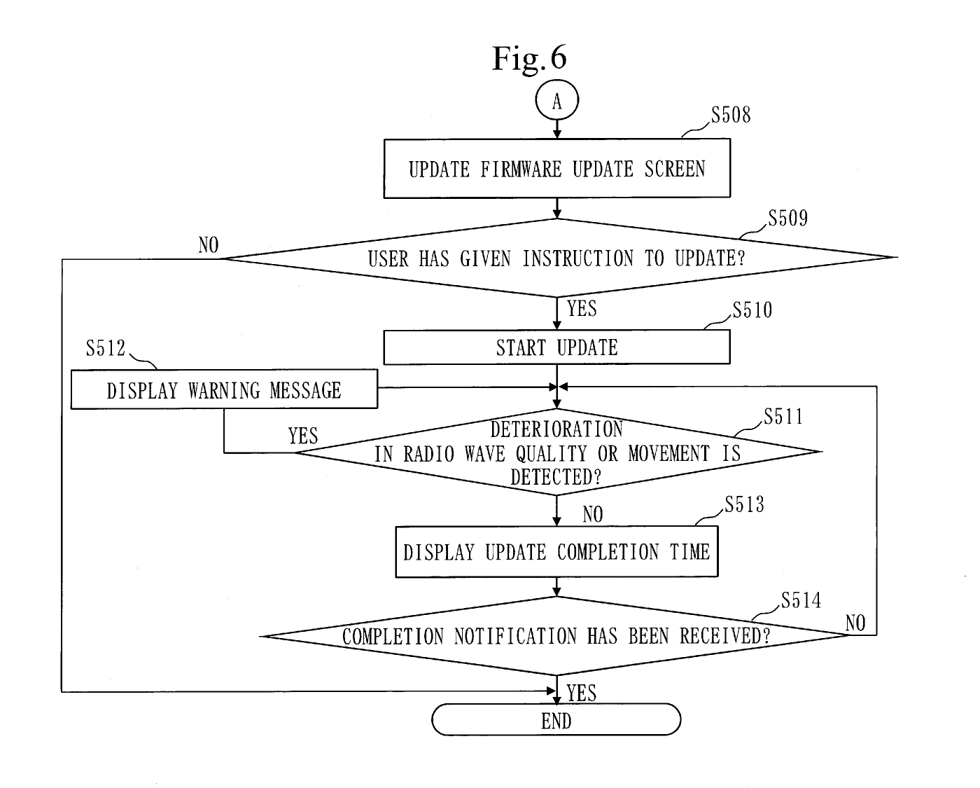

With reference to FIGS. 5 and 6, subsequently, an example of operations of the gateway device 105 according to the present embodiment will be described.

The update execution unit 404 searches for radio waves from the embedded appliance 106 with use of the near field communication unit 402. When the update execution unit 404 captures the radio waves from the embedded appliance 106 (YES in step S501), the update execution unit 404 receives identification information from the embedded appliance 106 through the near field communication unit 402 and further transmits the received identification information from the Internet communication unit 401 to the server device 109 (step S502).

Based on the identification information transmitted from the gateway device 105, the server device 109 searches for update status of the firmware of the corresponding embedded appliance 106. In case where the update firmware 102 exists, the server device 109 notifies the gateway device 105 that the update firmware 102 exists.

In the gateway device 105, when notified from the server device 109 that the update firmware 102 exists (YES in step S503), the update execution unit 404 downloads the update firmware 102 from the server device 109 through the Internet communication unit 401 (step S504).

The update execution unit 404 stores the downloaded update firmware 102 in the storage unit 410.

In case where the radio waves from a plurality of embedded appliances 106 are captured in step S501, the update execution unit 404 carries out operations of steps S502 to S504 for all the embedded appliances 106 from which the radio waves are captured.

Subsequently, the radio wave quality measurement unit 407 measures the radio wave quality in the radio communication links with the embedded appliances 106 to which the update firmware has been downloaded in step S504 (step S505). Specifically, the radio wave quality measurement unit 407 measures the radio wave quality based on the RSSI values. Then the radio wave quality measurement unit 407 outputs the measurement results to the update execution unit 404.

Subsequently, the update execution unit 404 generates the firmware update screen (FIG. 2) where the embedded appliances 106 to which the update firmware 102 has been downloaded in step S504 are displayed and the user interface unit 409 displays the firmware update screen (step S506).

On the firmware update screen that is displayed at this time point, names of the embedded appliances 106 (such as the air conditioner in FIG. 2), IDs of the embedded appliances 106 (such as ID: 00269208abe3 in FIG. 2), and versions of the embedded appliances 106 (such as Ver 1.0 (update to Ver 2.0) in FIG. 2) are displayed. The indicators that each represent the radio wave quality are displayed in the radio wave quality display areas 201. Meanwhile, “Updatable appliance” is not displayed for any of the embedded appliances 106 but “Appliance having update suspended” is displayed for all the embedded appliances 106. For any of the embedded appliances 106, no check box is then displayed in the update control area 202.

The update execution unit 404 outputs the measurement results of the radio wave quality measurement unit 407 to the determination unit 406.

The determination unit 406 determines whether the radio wave quality measured by the radio wave quality measurement unit 407 is satisfactory or not (step S507). Specifically, the determination unit 406 determines whether the RSSI value has exceeded a threshold for a given period or not. In case where the RSSI value has exceeded the threshold for the given period, it is determined that the radio wave quality is satisfactory.

When it is determined that the radio wave quality for any of the embedded appliances 106 is satisfactory (YES in step S507), the update execution unit 404 updates the firmware update screen (step S508). More specifically, the update execution unit 404 generates from the firmware update screen generated in step S506, a firmware update screen in which the check box is added in the update control area 202 and in which “Updatable appliance” is displayed for the embedded appliance 106 with the satisfactory radio wave quality. Then the user interface unit 409 displays the firmware update screen.

Subsequently, the update execution unit 404 determines whether the user has given the instruction to update the firmware or not (step S509).

When updating the firmware, the user validates the check box for the embedded appliance 106 that is the object of the update and presses the update button in the update execution area 203.

The update execution unit 404 determines whether the update button in the update execution area 203 has been pressed or not by the user.

In case where the user has given the instruction to update the firmware (YES in step S509), the update execution unit 404 starts to update the firmware of the embedded appliances 106 for which the check boxes are validated (step S510).

Specifically, the update execution unit 404 transmits the update firmware 102 stored in the storage unit 410 through the near field communication unit 402 to the embedded appliances 106 that are the objects.

In case where deterioration in the radio wave quality or the movement of the gateway device 105 is detected during the update of the firmware (YES in step S511), the update execution unit 404 generates the firmware update screen where the warning message is displayed in the warning display area 302 as illustrated in FIG. 3 and the user interface unit 409 displays the firmware update screen (step S512).

Specifically, the user interface unit 409 displays the warning message saying “Do not move during update.” or “Do not move appliance during update.” as described above.

When the radio wave quality is deteriorated, notification of the deterioration in the radio wave quality is given from the radio wave quality measurement unit 407 to the update execution unit 404. When the gateway device 105 is being moved, notification of the movement of the gateway device 105 is given from the gateway movement detection unit 408 to the update execution unit 404.

In case where the deterioration in the radio wave quality or the movement of the gateway device 105 is not detected (NO in step S511), the update execution unit 404 generates the firmware update screen where the update completion time is displayed in the completion time display area 301 as illustrated in FIG. 3 and the user interface unit 409 displays the firmware update screen (step S513).

Specifically, the update completion time prediction unit 405 has predicted the update completion time since a start of the update of the firmware in step S509. The update execution unit 404 generates the firmware update screen where the update completion time predicted by the update completion time prediction unit 405 is displayed in real time and the user interface unit 409 displays the firmware update screen.

The update completion time prediction unit 405 predicts the update completion time in accordance with a transmitting state of the update firmware 102 that is divided and transmitted from the Internet communication unit 401. On condition that the update firmware 102 of 100 KB is divided and transmitted 1 KB by 1 KB and that 50 KB therein has been transmitted, for instance, the update completion time is predicted with progress status determined as 50/100.

Upon the completion of the update of the firmware, the embedded appliance 106 transmits completion notification to the gateway device 105.

In the gateway device 105, the processes are ended when the update execution unit 404 receives the completion notification through the near field communication unit 402 from all the embedded appliances 106 that are the objects of the update of the firmware (YES in step S514).

***Description on Effects of Embodiment***

According to the present embodiment, the user is enabled to update the firmware at timing when the radio wave quality is satisfactory that is timing with a high possibility that the user may succeed in the update of the firmware. According to the present embodiment, therefore, the possibility that the user may succeed in the update of the firmware of the embedded appliances may be increased.

***Description on Hardware Configuration***

Finally, supplementary description on the hardware configuration of the gateway device 105 will be given.

The processor 601 illustrated in FIG. 7 is an IC (Integrated Circuit) that carries out processing.

The processor 601 is a CPU (Central Processing Unit), a DSP (Digital Signal Processor), or the like.

An OS (Operating System) is also stored in the flash memory 606.

At least a portion of the OS is executed by the processor 601.

While executing at least the portion of the OS, the processor 601 executes the programs that fulfil the function of the update control unit 403.

The processor 601 executes the OS, so that task management, memory management, file management, communication control, and the like are carried out.

The gateway device 105 may include a plurality of processors that substitute for the processor 601. Execution of the programs that fulfil the function of the update control unit 403 is divided among the plurality of processors. Each of the processors is an IC that carries out processing as with the processor 601.

Information, data, signal values, variable values, and the like that indicate results of processing in the update control unit 403 are stored in at least any of the RAM 603, the flash memory 606, and a register and a cache memory in the processor 601.

The programs that fulfil the function of the update control unit 403 may be stored in a portable storage medium such as a magnetic disk, a flexible disk, an optical disk, a compact disk, a Blu-ray (a registered trademark) disk, or a DVD.

The “unit” in the update control unit 403 may be read as the “circuit”, the “step”, the “procedure”, or the “processing”.

The gateway device 105 may be implemented by an electronic circuit such as a logic IC (Integrated Circuit), a GA (Gate Array), an ASIC (Application Specific Integrated Circuit), or an FPGA (Field-Programmable Gate Array).

In this case, the update control unit 403 is each implemented as a portion of the electronic circuit.

The processor and the electronic circuits may be collectively referred to as processing circuitry.

### REFERENCE SIGNS LIST

100: firmware update system; 101a: appliance vendor A; 101b: appliance vendor B; 102: update firmware; 102a: update firmware A; 102b: update firmware B; 105: gateway device; 106: embedded appliance; 106a: embedded appliance A; 106b: embedded appliance B; 107a: microcomputer A; 107b: microcomputer B; 109: server device; 201: radio wave quality display area; 202: update control area; 203: update execution area; 301: completion time display area; 302: warning display area; 401: Internet communication unit; 402: near field communication unit; 403: update control unit; 404: update execution unit; 405: update completion time prediction unit; 406: determination unit; 407: radio wave quality measurement unit; 408: gateway movement detection unit; 409: user interface unit; 410: storage unit; 601: processor; 602: ROM; 603: RAM; 604: display; 605: near field communication controller; 606: flash memory; 607: Internet communication controller; 608: sensor

1.-10. (canceled)

11. A gateway device being portable, comprising:
processing circuitry to:
measure radio wave quality in a radio communication link with an embedded appliance in which firmware is installed;
determine whether update firmware for update of the firmware is to be transmitted through the radio communication link to the embedded appliance or not, based on a measurement result on the radio wave quality;
detect movement of the gateway device; and
output a message that requests a user of the gateway device to stop the movement of the gateway device when the movement of the gateway device is detected.

12. A gateway device comprising:
processing circuitry to:
measure radio wave quality in a radio communication link with an embedded appliance which is portable and in which firmware is installed;
determine whether update firmware for update of the firmware is to be transmitted through the radio communication link to the embedded appliance or not, based on a measurement result on the radio wave quality;
detect movement of the embedded appliance; and
output a message that requests a user of the gateway device to stop the movement of the embedded appliance when the movement of the embedded appliance is detected.

13. The gateway device according to claim 11, wherein
the processing circuitry transmits the update firmware through the radio communication link to the embedded appliance in case where it is determined that the update firmware is to be transmitted through the radio communication link to the embedded appliance and where an instruction to transmit the update firmware to the embedded appliance is given from the user of the gateway device.

14. The gateway device according to claim 11, wherein
the processing circuitry outputs the measurement result on the radio wave quality.

15. The gateway device according to claim 14, wherein
the processing circuitry measures the radio wave quality in the radio communication link for each embedded appliance of a plurality of embedded appliances, and
the processing circuitry outputs the measurement result on the radio wave quality for each embedded appliance.

16. The gateway device according to claim 15, wherein
the gateway device is a portable gateway device, and
the processing circuitry outputs a message that requests the user of the gateway device to make the gateway device closer to an embedded appliance for which the radio wave quality measured is lower than predetermined quality.

17. The gateway device according to claim 11, wherein
the processing circuitry predicts update completion time that is time until completion of the update of the firmware, and
the processing circuitry outputs the update completion time predicted.

18. A firmware update method comprising:
measuring, by a gateway device which is portable, radio wave quality in a radio communication link with an embedded appliance in which firmware is installed;
determining, by the gateway device, whether update firmware for update of the firmware is to be transmitted through the radio communication link to the embedded appliance or not, based on a measurement result on the radio wave quality;
detecting, by the gateway device, movement of the gateway device; and
outputting, by the gateway device, a message that requests a user of the gateway device to stop the movement of the gateway device when the movement of the gateway device is detected.

19. A firmware update method comprising:
measuring, by a computer, radio wave quality in a radio communication link with an embedded appliance which is portable and in which firmware is installed;
determining, by the computer, whether update firmware for update of the firmware is to be transmitted through the radio communication link to the embedded appliance or not, based on a measurement result on the radio wave quality;
detecting, by the computer, movement of the embedded appliance; and
outputting, by the computer, a message that requests a user of the computer to stop the movement of the embedded appliance when the movement of the embedded appliance is detected.

20. A non-transitory computer readable medium storing a firmware update program that causes a gateway device being portable, to execute:
a radio wave quality measurement process of measuring radio wave quality in a radio communication link with an embedded appliance in which firmware is installed;
a determination process of determining whether update firmware for update of the firmware is to be transmitted through the radio communication link to the embedded appliance or not, based on a measurement result in the radio wave quality measurement process;
a gateway movement detection process of detecting movement of the gateway device; and
a message output process of outputting a message that requests a user of the gateway device to stop the movement of the gateway device when the movement of the gateway device is detected in the gateway movement detection process.

21. A non-transitory computer readable medium storing a firmware update program that causes a computer to execute:
a radio wave quality measurement process of measuring radio wave quality in a radio communication link with an embedded appliance which is portable and in which firmware is installed;
a determination process of determining whether update firmware for update of the firmware is to be transmitted through the radio communication link to the embedded appliance or not, based on a measurement result in the radio wave quality measurement process;
an appliance movement detection process of detecting movement of the embedded appliance; and
a message output process of outputting a message that requests a user of the computer to stop the movement of the embedded appliance when the movement of the embedded appliance is detected in the appliance movement detection process.

22. The gateway device according to claim 12, wherein
the processing circuitry transmits the update firmware through the radio communication link to the embedded appliance in case where it is determined that the update firmware is to be transmitted through the radio communication link to the embedded appliance and where an instruction to transmit the update firmware to the embedded appliance is given from the user of the gateway device.

23. The gateway device according to claim 12, wherein
the processing circuitry outputs the measurement result on the radio wave quality.

24. The gateway device according to claim 23, wherein
the processing circuitry measures the radio wave quality in the radio communication link for each embedded appliance of a plurality of embedded appliances, and
the processing circuitry outputs the measurement result on the radio wave quality for each embedded appliance.

25. The gateway device according to claim 24, wherein
the gateway device is a portable gateway device, and
the processing circuitry outputs a message that requests the user of the gateway device to make the gateway device closer to an embedded appliance for which the radio wave quality measured is lower than predetermined quality.

26. The gateway device according to claim 12, wherein
the processing circuitry predicts update completion time that is time until completion of the update of the firmware, and
the processing circuitry outputs the update completion time predicted.
